(19) United States
(12) Patent Application Publication
(10) Pub. No.: US 2025/0111162 A1
(43) Pub. Date: Apr. 3, 2025

(54) OPTIMIZED CONTENT DELIVERY USING INTENT CLASSIFICATION AND QUERY REFINEMENT

(71) Applicant: Microsoft Technology Licensing, LLC, Redmond, WA (US)

(72) Inventors: Xinyu HU, Redmond, WA (US); Pengfei TANG, Redmond, WA (US); Simiao ZUO, Redmond, WA (US); Qiang LOU, Redmond, WA (US); Jian JIAO, Redmond, WA (US); Denis Xavier CHARLES, Redmond, WA (US); Eren MANAVOGLU, Menlo Park, CA (US)

(21) Appl. No.: 18/478,922

(22) Filed: Sep. 29, 2023

(51) Int. Cl. G06F 40/35; G06F 16/33; G06F 40/40

(52) U.S. Cl. CPC G06F 40/35; G06F 16/334; G06F 40/40

(57) ABSTRACT

A computing system is disclosed that includes a processor and memory. The memory stores instructions that, when executed by the processor, cause the processor to perform several acts. The acts comprise receiving conversational data indicative of an interaction between a client computing device and a generative model. The conversational data is provided as input into an intent classification module and the intent classification module produces an output indicative of a user intent based upon the conversational data. An anchor generation module generates anchor text indicative of portions of the conversational data correlated with the user intent. A content query based upon the anchor text is generated and content responsive to the content query is obtained and presented at the client computing device.

### BACKGROUND

A conventional online search experience generally involves a computer-implemented search engine receiving a query from a user operating a client computing device, identifying results that are relevant to the query, and returning the results to the client computing device for presentation to the user. In addition to returning results responsive to the query, the search engine may also facilitate presentation of content that is supplementary to the search results. For example, receiving a query related to a certain recipe may cause the search engine to return results for webpages containing that recipe. The search engine may additionally cause content related to a restaurant that serves a dish from the recipe to be presented along with the webpage results. The content may function similar to the search results, such that when the content is interacted with by the user, additional content (e.g., a webpage) related to the content may be presented to the user.

Conventionally, supplementary content is identified and retrieved based upon a content query separate from the query input by the user. The content query is generated using keywords extracted from the query input by the user and/or the search results returned by the search engine. Relying on keywords to identify supplementary content is deficient for many types of queries that lack contextual information outside of the keywords provided within the input query. More specifically, conventional use of keywords to identify supplementary content fails to consider aspects of the input query that may not be adequately expressed through the keywords alone (e.g., a specific intent). The resulting supplementary content may lack relevance to the initial query, and thus decreases the likelihood that the supplementary content will be interacted with by the user.

Relatively recently, generative models have been developed to create a conversational interactive user experience. Generative models include generative language models (GLMs) (also referred to as large language models (LLMs)). These generative models are configured to generate an output (such as text in human language, source code, music, video, and the like) based upon input set forth by a user and in near real-time (e.g., within a few seconds of receiving the input). A generative model generates content based upon training data over which the generative model has been trained. While this results in an interactive query-response experience, the generative model is limited to generate content based upon its training data, which can become stale over time.

### SUMMARY

The following is a brief summary of subject matter that is described in greater detail herein. This summary is not intended to be limiting as to the scope of the claims.

Various technologies are described herein that relate to providing intent-specific content to a client computing device based upon conversational data. In an example, the conversational data is representative of an interaction between the client computing device and a generative model. When input set forth by a user of the client computing device is provided to the generative model, the generative model is configured to generate a responsive output. The user may set forth additional input based upon the output of the generative model, triggering further output by the generative model. The interaction between the client computing device and the generative model may iterate several times over in a conversational manner, with each user input accompanied by a responsive output by the generative model. Accordingly, the conversational data is representative of the interaction between the client computing device and the generative model. In an example, “conversational data” comprises an input set forth by the user and the responsive output of the generative model during an interaction, or a portion thereof.

In accordance with technologies described herein, a computing system comprising a content delivery module receives conversational data, for example, from a generative model. In an example, an input (e.g., query) set forth by a user at a client computing device is received at an entry point for interaction with a generative model, such as a webpage with a conversational “chatbot” or the like, where input received from a user may be indicative of a desire to interact with the generative model. A browser of a client computing device loads a webpage that is configured to receive the input (e.g., by way of text, voice, or the like) and the browser receives the input set forth by a user of the client computing device. The input is provided to the generative model and the generative model generates a responsive output which is in turn presented to the user at the client computing device. The user may set forth additional input triggering further output by the generative model and so on and so forth, creating conversational data.

The computing system comprising the content delivery module receives the conversational data, for example, from the generative model. In some examples, the conversational data is passed from the generative model to one or more intermediary sources which in turn provide the conversational data to the content delivery module. The content delivery module comprises an intent classification module configured to generate an output indicative of a user intent based upon the conversational data. The intent classification module comprises a classification model (e.g., a generative model, a sequence-to-sequence (seq2seq) model, etc.) that has been trained to analyze input and produce an output that is indicative of an intent associated with the input. The classification model may be trained using a corpus of data indicative of a specific intent, such that the classification model produces an output indicative of the specific intent.

The content delivery module provides conversational data and the output of the intent classification module as input into an anchor generation module. The anchor generation module generates anchor text, wherein the anchor text is indicative of one or more portions of the conversational data correlated with the user intent (as indicated by the output of the intent classification module). The anchor text may include tokens of the conversational data that are correlated with the intent. Accordingly, the anchor text can be a word, a portion of a word, or a string of words together. In an example, the anchor generation module uses a loss function to extract contiguous substrings of anchor text. As another example, the anchor generation module uses a start and end token classification system to identify anchor text.

The anchor text is then provided as input into a content query generation module. The content query generation module is configured to generate a content query based upon the anchor text. Because the anchor text is indicative of the portions of the conversational data that are correlated with the user intent, the query generated by the query generation module will elicit intent-specific results from a search engine or other suitable source. Generating the content query based upon the anchor text is therefore advantageous over conventional keyword-based approaches to identifying supplementary content because the content query will result in more contextually appropriate content results than a query based on keywords. The content query generation module may further generate the content query based upon user profile information, historical data (e.g., conversational data from prior interactions between the user computing device and the generative model), results from web-based queries, etc., in addition to the anchor text.

Upon generation of the content query, the content delivery module obtains content responsive to the content query. In an example, the content delivery module may receive content from a content server based upon the content query. The content server may facilitate a content acquisition service whereby different content providers can provide content responsive to the content query. In a further example, the content acquisition service can solicit content in an auction format, whereby different content providers can provide bids for the opportunity to provide the content to the content delivery module. The content delivery module may provide the content providers certain information relating to the user of the client computing device (e.g., user profile information, demographic information, information relating to current or past conversational data, etc.). In another example, the content delivery module may generate content based upon the content query. Content generated by the content delivery model may comprise content stored in an asset data store, or new content may be generated using content stored in the asset data store (e.g., by way of a generative model).

As content is obtained by the content delivery module, the content delivery module selects the content to be presented to the user at the client computing device. The content delivery module comprises a content selection module configured to evaluate the content obtained responsive to the content query, and determine metrics related to potential interaction with the content when presented at the client computing device. In an example, the content selection module further considers information related to a particular user of the client computing device when making a content selection. For instance, the content selection module may consider user profile information including information about the user, including demographic information about the user, browsing history, dialog history which relates to prior interactions between the user of the client computing device and the generative model. Once content is selected by the content selection module, the content delivery module causes the content to be presented to the user at the client computing device. The content may be presented within an interface associated with the generative model or may be displayed as a graphical object overlay presented on top of the generative model interface. In another example, the content is displayed at a browser executing on the client computing device. Content displayed at a browser may be displayed in addition to (for example, supplementary to) other webpage content.

The technologies described herein exhibit various advantages over conventional search engine and/or generative model technologies. When presenting content that is supplementary to search results returned in response to a search query, conventional search engines rely on keywords to identify supplementary content. The conventional use of keywords to identify this content fails to consider aspects of the input query that may not be adequately expressed through the keywords alone (e.g., a specific intent). Generative models provide an interactive query-response experience. However generative models are not configured to identify and retrieve additional content external from the generative model that is relevant to input provided to the generative models or responses generated by the generative models. Even if a generative model were configured to identify and return such content to a user, problems associated with conventional keyword extraction (referenced above) would remain unaddressed. These deficiencies are addressed by the technologies described herein.

For example, the content provided by the content delivery module is more contextually appropriate than content identified using conventional keyword extraction because it is based upon conversational data. Specifically, because the anchor text generated by the content delivery module is based upon the conversational data and the user intent (as indicated by the intent classification module), the resulting content query returns content that is intentionally correlated with the user intent, and therefore more likely to be interacted with at the client computing device. This reduces computational resources required to run the generative model by providing intent-driven supplemental content in addition to the content output by the generative model. Furthermore, the supplemental content provided to the client computing device may result in more specifically targeted subsequent input (or satisfy the initial query) from the user which results in fewer iterations of the generative model needed to identify relevant information responsive to the initial input.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of a computing system that facilitates interaction between a client computing device and a generative model.

FIG. 2 is a communications flow diagram that illustrates an example flow of communications between component modules of a content delivery module.

FIG. 3 is another functional block diagram of a computing system that facilitates interaction between a client computing device and a generative model.

FIG. 4 depicts a graphical user interface (GUI) of a browser displaying a generative model interface by way of which communications are provided to and received from a generative model.

FIG. 5 depicts a graphical user interface (GUI) of a browser displaying a webpage content and a generative model interface.

FIG. 6 is another depiction of a graphical user interface (GUI) of a browser displaying a webpage content and a generative model interface.

FIG. 7 is a flow diagram illustrating a methodology for providing content to a user computing device.

FIG. 8 is a schematic of an exemplary computing system.

### DETAILED DESCRIPTION

Various technologies pertaining to providing content to a client computing device based upon conversational data resulting from an interaction between the client computing device and a generative model are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as an example, the terms “component”, “system”, “model”, “engine”, and “module” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

The technologies described herein relate to providing content based upon conversational data resulting from interaction between a client computing device and a generative model. The technologies described herein provide targeted and personalized digital content which is supplemental to the output of a generative model and/or a search engine. The supplemental content is correlated with an intent identified within the conversational data and is therefore more likely to be relevant and of interest to the user of the client computing device who is interacting with the generative model. Providing the supplemental content to the client computing device may reduce overall computational resources consumed by satisfying the intent of an initial query faster than executing multiple searches and/or conversational iterations with a generative model.

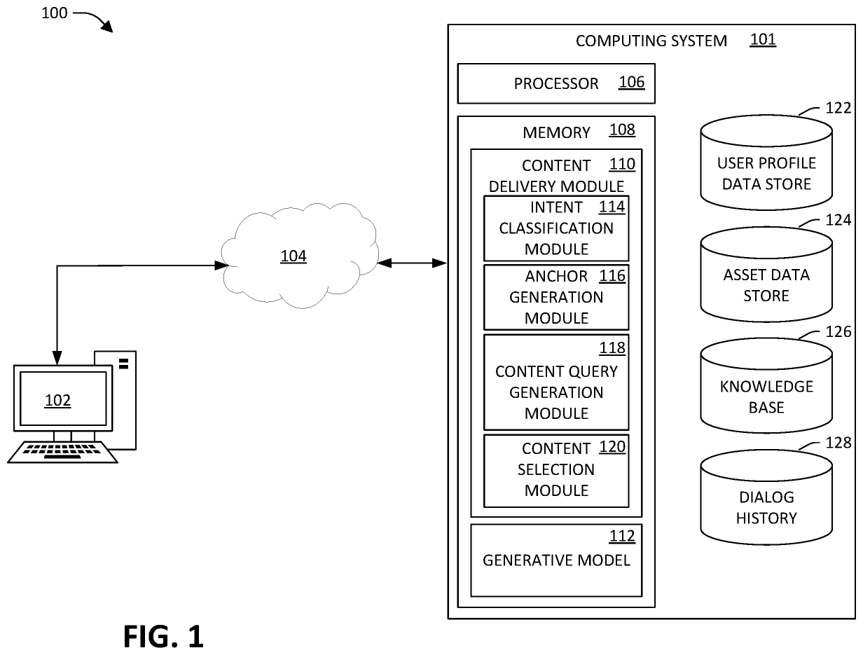

Referring now to FIG. 1, a functional block diagram of a system 100 is illustrated. System 100 comprises a computing system 101 and a client computing device 102. While illustrated as a single system, it is to be understood that the computing system 101 may comprise several server computing devices, can be distributed across computing systems, data centers, etc. The computing system 101 is configured to obtain conversational data based upon interactions between the client computing device 102 and a generative model (e.g., generative model 112) associated with computing system 101. The conversational data comprises at least an input (e.g., query) set forth by a user of client computing device 102 which is provided to the generative model, and the output generated by the generative model responsive to the input.

The client computing device 102 is operated by a user and is in communication with the computing system 101 by way of a network 104. The client computing device 102 can be any suitable type of client computing device, such as a desktop computer, a laptop computer, a tablet (slate) computing device, a video game system, a virtual reality or augmented reality computing system, a mobile telephone, a smart appliance, or other suitable computing device.

The computing system 101 includes a processor 106 and memory 108, where the memory 108 includes instructions that are executed by the processor 106. More specifically, the memory 108 comprises a content delivery module 110 and the generative model 112, where operations of the content delivery module 110 and the generative model 112 are described in greater detail below. In an example, the generative model 112 is a generative language model (GLM), although it is to be understood that the generative model 112 can output images, video, etc. GLMs may also be referred to herein as large language models (LLMs). An example of a GLM is the Generative Pre-trained Transformer (e.g., GPT-3, GPT-4, etc.). Another example of a GLM is the BigScience Language Open-science Open-access Multilingual (BLOOM) model. It is understood that computing system 101 may be readily adapted for use with any generative model beyond those offered by way of example herein. In certain embodiments, content delivery module 110 also comprises one or more generative models (or instances thereof) configured to perform the operations of the content delivery module 110 as described herein.

The computing system 101 also includes data stores 122-128, where the data stores 122-128 store data that is accessed by the content delivery module 110 and/or the generative model 112. With more particularity, the data stores 122-128 include a user profile data store 122, an asset data store 124, a knowledge base 126, and a dialog history data store 128. While illustrated separately, it is appreciated that information as described as being associated with data stores 122-128 may be combined into a single data store and/or distributed amongst many different data stores. The information within data stores 122-128 may be accessed/obtained by the content delivery module 110 via a query constructed by the content delivery module 110.

The user profile data store 122 comprises user profiles with user profile information relating to users (e.g., users of client computing device 102). A user profile within the user profile data store 122 may contain information relating to a particular user's web-based activity, such as prior input queries and corresponding search results, demographic information, geolocation data, user preferences, topics the user is interested in, products the user has purchased, etc. A user profile (or information contained therein) may be used by the content delivery module 110 to provide more personalized content to the client computing device for presentation to the user.

The asset data store 124 comprises content assets that are provided by content providers. In an example, the content assets comprise content that is pre-formatted for display at the client computing device. In another example, the content assets may comprise textual information, images, videos, etc., that can be used by the content delivery module 110 to generate content for presentation at the client computing device 102. In an example, a content asset comprises information about a product or brand, such as an advertisement.

The knowledge base 126 comprises information that may be used by the content delivery module 110 to train one or more models associated with the content delivery module. The knowledge base 126 further comprises information that may be used by the content delivery module 110 to provide “grounding” information to the generative model 112 to influence the output of the generative model. “Grounding” relates to providing the generative model with information that is usable by the generative model to generate output. Grounding the generative model refers to providing the generative model with context that is usable by the generative model to generate output, where the context is in addition to user-generated input. With more specificity, a generative model generates output based upon a prompt; the prompt can include input generated by a user who is interacting with the generative model during a conversation (such as a query set forth by a user), previous inputs set forth by the user during the conversation, previous outputs generated by the generative model during the conversation, and previously defined instructions that describe how the generative model is to generate output. Certain aspects of the knowledge base 126 may correspond to a specific user intent. For example, a commercial intent corpus corresponds to a shopping or commercial intent and may comprise information relating to certain products, brands, merchants, buying guides, etc., that can be used to ground the generative model to produce output specific to that intent. The knowledge base 126 may comprise both static and dynamic data.

The dialog history data store 128 includes dialog history, where the dialog history includes conversational data with respect to users and the generative model 112. For instance, the dialog history can include, for a user, identities of conversations undertaken between the user and the generative model 112, input provided to the generative model 112 by the user for multiple dialog turns during the conversation, dialog turns in the conversation generated by the generative model 112 in response to the inputs from the user, queries generated by the generative model 112 during the conversation that are used by the generative model 112 to generate responses, and so forth. In addition, the dialog history can include content obtained by the content delivery module 110; for instance, with respect to a conversation, the dialog history 128 can include content from results identified based upon queries set forth by the user and/or the generative model 112 during the conversation, content from information identified by the content delivery module 110 based upon queries set forth by the user and/or the generative model 112 during the conversation, and so forth.

The data stores 122-128 are presented to show a representative sample of types of data that are accessible to the content delivery module 110 and/or the generative model 112; it is to be understood that there are many other sources of data that are accessible to the content delivery module 110 and/or the generative model 112, such as data stores that include real-time finance information, data stores that include real-time weather information, data stores that include real-time sports information, data stores that include images, data stores that include videos, data stores that include maps, etc. Such sources of information are available to the content delivery module 110 and/or the generative model 112.

The content delivery module 110 comprises an intent classification module 114, an anchor generation module 116, a content query generation module 118, and a content selection module 120. While described as separate components, it is appreciated that each operation performed by intent classification module 114, anchor generation module 116, content query generation module 118, and content selection module 120, may also be described as being performed by content delivery module 110.

The content delivery module 110 receives conversational data, for example, from the generative model 112. As described herein, the conversational data comprises all or a portion of the information exchanged between the client computing device 102 and the generative model 112 (e.g., the input set forth by the user and the corresponding output generated by the generative model). In an example, the content delivery module 110 analyzes the conversational data to determine if the nature of the conversational data is appropriate for content delivery by the content delivery module 110. For instance, the content delivery module 110 will not provide content delivery when the conversational data is indicative of certain inappropriate subject matter (e.g., drugs, alcohol, or other adult subject matter).

Upon the content delivery model determining that the nature of the conversational data is appropriate for content delivery, the content delivery module 110 provides the conversational data as input into the intent classification module 114. The intent classification module 114 then produces an output indicative of an intent associated with the conversational data. The intent classification module 114 may comprise a classification model trained on intent-specific information such that output of the intent classification module 114 is indicative of an intent associated with the input (e.g., “what is a good birthday gift for someone interested in cooking?” may be classified as a commercial intent, since the query is intended to return products that are available to purchase as a gift). The output indicative of an intent is representative of an objective related to the interaction between the client computing device 102 and the generative model 112, such as, for example, finding a birthday gift (i.e., a commercial intent). In some examples, the intent classification module 114 may be further configured to produce an output indicative of a sentiment associated with the conversational data. In another example, the content delivery module 110 provides the conversational data and search engine results (e.g., related to an initial user query) as input into the intent classification module 114. The intent classification module 114 can then produce an output indicative of a user intent based upon the conversational data and the search engine results.

In certain embodiments, the intent classification module 114 is configured to utilize generative model 112 to perform intent classification on the conversational data. For example, the intent classification module 114 is configured to generate an intent classification prompt to provide as input into the generative model 112. The intent classification prompt may include the conversational data as well as additional contextual information, such as user profile information, search engine results related to user queries, etc., which further ground the intent classification prompt. The intent classification module 114 may then provide the intent classification prompt to the generative model 112 and the generative model 112 will produce an output indicative of an intent associated with the conversational data. In another example, the intent classification module utilizes generative model 112 as described above to create training data for training a different, non-generative model (e.g., a sequence-to-sequence model) which can be used at runtime instead of the generative model 112. As generative models are associated with a certain latency, a faster model may be used to perform intent classification by the intent classification module 114 at runtime.

The content delivery module 110 further comprises an anchor generation module 116. The anchor generation module 116 is configured to receive the conversational data and the output of the intent classification module 114 as input, and in response, generate anchor text as output. Anchor text is indicative of one or more portions of the conversational data correlated with the user intent (as indicated by the output of the intent classification module 114). The anchor text may be comprised of tokens that are correlated with the intent. In an example, each token of the conversational data is determined to be correlated (or not correlated) with the user intent as indicated by the output of the intent classification module 114. Accordingly, the anchor text can be a word, a portion of a word, or a string of words together. In an example, the anchor generation module 116 uses a loss function to extract contiguous substrings of anchor text. As another example, the anchor generation module 116 uses a start and end token recognition classification system to identify anchor text.

In certain embodiments, the anchor generation module 116 is configured to utilize generative model 112 to perform anchor generation. For example, the anchor generation module 116 is configured to generate an anchor text generation prompt to provide as input into the generative model 112. The anchor text generation prompt may include the conversational data and the output of the intent classification module 114, as well as additional contextual information, such as information from a user profile, search engine results related to user queries, etc., which further ground the anchor generation prompt. The anchor generation module 116 then provides anchor generation prompt to the generative model 112 and the generative model 112 produces an output indicative anchor text within the conversational data, i.e., portions of the conversational data that are correlated with the user intent (as indicated by the output of the intent classification module 114). In another example, the intent classification module 114 utilizes generative model 112 as described above to create training data for training a different, non-generative model (e.g., a sequence-to-sequence model) which can be used at runtime instead of the generative model. As generative models are associated with a certain latency, a faster model may be used to perform anchor generation by the anchor generation module 116 at runtime.

The content delivery module 110 further comprises a content query generation module 118. The content query generation module 118 generates a content query based upon the anchor text as generated by the anchor generation module 116. In some examples, a content query is generated for each anchor text portion such that separate content may be returned for each contiguous portion of anchor text. Alternatively, all anchor text may be considered together for purposes of generating the content query. In an example, the content query generation module 118 generates a content query prompt to provide as input into generative model 112. The content query prompt comprises the anchor text and additional grounding information that cause the generative model 112 to produce an output comprising a content query. The additional grounding information provided as part of the content query prompt may comprise user side grounding (e.g., user profile information from user profile data store 122, historical dialog information from dialog history 128, etc.) and/or grounding information obtained from external sources (e.g., search engine results based upon the conversational data, anchor text, etc.). In another example, the content query generation module 118 generates a content query using a seq2seq model. The seq2seq model may be trained using training data generated from generative model 112. The content query generation module 118 provides the anchor text, information from a user profile, and the conversational data as input into the seq2seq model, wherein the seq2seq model is configured to produce an output comprising a content query. In an example, the input provided to the seq2seq model is approximately 500 tokens and the output generated by the seq2seq model is approximately 32 tokens.

Upon generation of the content query, the content delivery module 110 obtains content based upon the content query. In an example, the content delivery module 110 obtains content based upon the content query from a content server. The content server may facilitate a content acquisition service whereby different content providers can provide content responsive to the content query. In a further example, the content acquisition service can solicit content in an auction format, whereby different content providers can provide bids for the opportunity to provide the content to the content delivery module 110. The content delivery module may provide the content providers certain information relating to the user of the client computing device (e.g., user profile information, demographic information, information relating to current and/or past conversational data, etc.). In another example, the content delivery module 110 may generate content based upon the content query. Content generated by the content delivery model 110 may comprise content stored in asset data store 124, or new content may be generated using content stored in the asset data store 124 (e.g., by way of generative model 112). In an example, the content delivery module 110 may generate a content generation prompt to provide as input into generative model 112. The content generation prompt may comprise the content query, the anchor text, one or more assets from the asset data store 124 that are responsive to the query, and/or additional grounding information. When the content generation prompt is provided as input into the generative model 112, the generative model 112 generates content based upon the prompt. In another example, the content delivery module generates content responsive to the content query using a seq2seq model. The seq2seq model may be trained using training data generated from generative model 112. The content query generation module 118 provides content query and one or more assets from asset data store 124 as input into the seq2seq model wherein the seq2seq model is configured to produce an output comprising generated content. In some examples, the generated content is textual content that is representative of one or more of the assets from the asset data store 124 which was provided as part of the input into the generative model 112 and/or the seq2seq model.

The content delivery module 110 further comprises the content selection module 120. As content is obtained by the content delivery module 110, the content selection module 120 selects which content is to be presented to the user at the client computing device. The content selection module 120 evaluates the content obtained responsive to the content query, and determine metrics related to potential interaction with the content when presented at the client computing device 102. In an example, the content selection module 120 determines a score representative of the likelihood that the user of the client computing device 102 will interact with the content. The score may be based upon prior interactions between the user and content provided by the content delivery module 110. For example, content related to prior content that received positive interaction (e.g., activation of the content at the client computing device 102) may have a higher score than content which received negative or no interaction. The content selection module 120 selects appropriate content for presentation to the user at the client computing device 102 based upon the metrics. The content selection operation performed by the content selection module 120 offer an advantage over conventional systems which would display all content returned by a content query. By evaluating the content and determining the likelihood that the user will interact with the content, the overall computing resources required to provide supplemental content are reduced as fewer supplemental content will need to be displayed at the client computing device.

Once content is selected by the content selection module 120, the content delivery module 110 causes the content to be presented to the user at the client computing device 102. The content may be presented within an interface associated with the generative model 112 or may be displayed as a graphical object overlay presented on top of the generative model interface. In an example, anchor text within the conversational data is graphically emphasized when displayed at the generative model interface (underlined, bolded, increased font size, etc.). When a user interacts with the anchor text (e.g., via a cursor “hover”, click, etc.) the content is caused to be displayed as a graphical object overlay on top of the generative model interface. In another example, the content is displayed at a browser executing on the client computing device 102. Content displayed at a browser may be displayed in addition to other webpage content displayed by the browser.

As discussed above, the operation of the content delivery module 110 as described herein exhibits various advantages over supplemental content delivery using conventional search engine and/or generative model technologies. For example, the content provided by the content delivery module 110 is more contextually appropriate than content identified using conventional keyword extraction because it is based upon conversational data extracted from the interaction between the user of the client computing device 102 and the generative model 112. More specifically, because the anchor text used by the content delivery module 110 to generate the content query is based upon the conversational data and the user intent (as indicated by the intent classification module), the resulting content query is more likely to return content that is correlated with the user intent, and therefore more likely to be interacted with at the user at client computing device 102. The aforementioned advantage is further reinforced by the content selection module 120 which determines metrics related to the likelihood of interaction with the content responsive to the content query. This reduces computational resources required to run the generative model by providing intent-driven content in addition to the content output by the generative model (for example, supplemental content). Furthermore, the content provided to the client computing device may result in more specifically targeted subsequent input (or satisfy the initial query) from the user which results in fewer iterations of the generative model needed to identify relevant information responsive to the initial input.

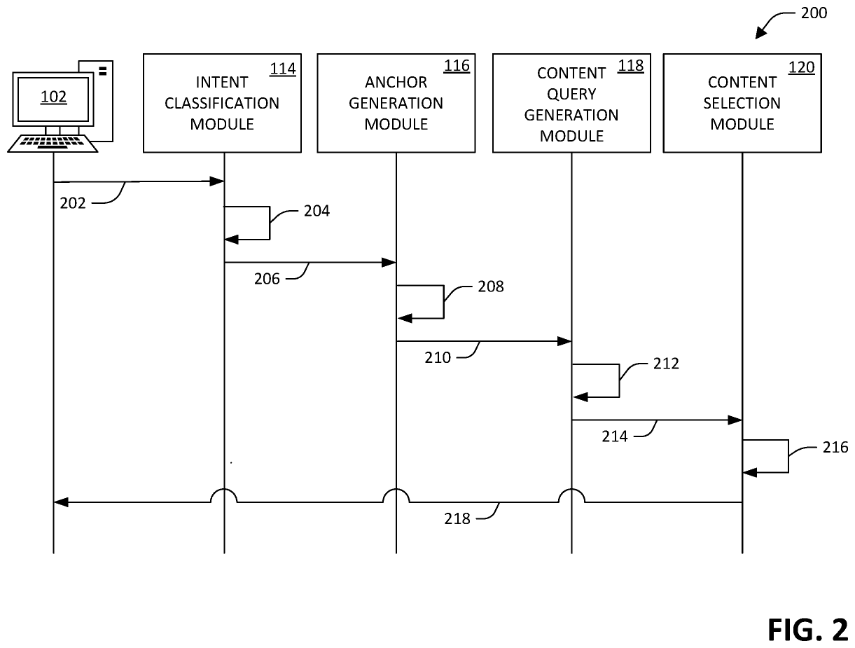

Examples of operation of the computing system 101 are now set forth. It is to be understood that these examples are non-limiting, and that permutations of such examples are contemplated. Referring to FIG. 2, a communications diagram 200 depicting communications between the client computing device 102 and the content delivery module 110 and its component modules (e.g., intent classification module 114, anchor generation module 116, content query generation module 118, and content selection module 120) in accordance with a first example is presented. The client computing device 102 is executing an application such as a web browser, and the application receives a query (user input) that is to be transmitted to the generative model 112. For instance, the web browser can load a homepage related to the generative model 112 and the web browser receives a query from a user in a text entry field indicative of a user intent to interact with the generative model 112. The generative model 112 produces an output responsive to the user input, creating conversational data. At 202, the conversational data is transmitted to the intent classification module 114.

At 204, the intent classification module 114 receives the conversational data and generates an output indicative of an intent associated with the conversational data. The intent is indicative of an objective related to the input, such as, for example, a commercial intent. The intent may be further refined into a sub-intent (i.e., shopping may be a sub-intent of commercial intent). Output of the intent classification module may comprise multiple layered and/or combined intents. For example, an input of “what are the best tennis shoes made by X Brand?” may be determined by the intent classification module has having a global shopping intent, while having a branding intent (e.g., “X Brand”) and a category intent (“tennis shoes”). At 206, the output of the intent classification module 114 and the conversational data are provided to anchor generation module 116. At 208, anchor generation module generates anchor text indicative of portions of the conversational data correlated with the user intent (as indicated by the output of the intent classification module 114). At 210, the anchor text is provided to the content query generation module 118 to generate a content query. At 212, the content query generation module 118 generates a content query based upon the anchor text.

At 214, content query generated by the content query generation module 118 is executed (e.g., by content delivery module 110) and content responsive to the query is obtained by the content delivery module 110. At 216, the content selection module evaluates the content obtained by the content delivery module 110 and selects content for presentation to the client computing device 102. At 218, the content is presented to the user at the client computing device 102. It is appreciated that the process as depicted in communications diagram 200 may be repeated as conversational data is obtained from the generative model 112 and/or the client computing device 102. For example, as the interaction between the user operating client computing device 102 and the generative model 112 progresses, additional conversational data is created. The content delivery module 112 may receive updated conversational data as each dialog turn of the generative model 112 is processed. Accordingly, as the interaction advances, the resulting anchor text, content queries, and ultimately content selection will be affected by the newly received conversational data.

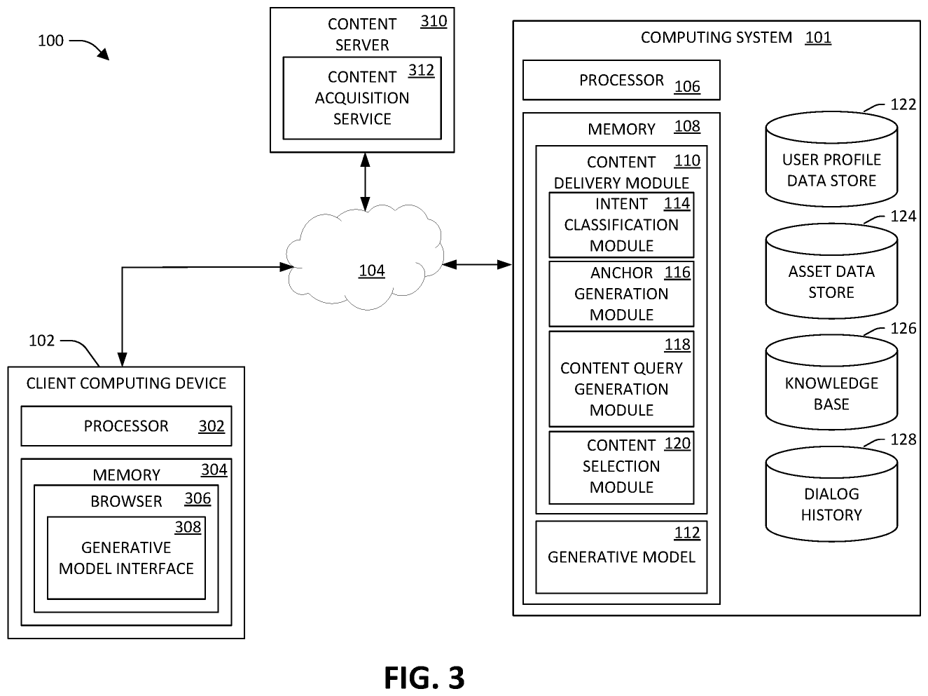

The communications diagram in FIG. 2 represents a high-level aspect of the communication between the client computing device 102 and the content delivery module 110. Further aspects and features will now be described with reference to FIG. 3.

With reference now to FIG. 3, another functional block diagram of the system 100 is presented. The computing system 101 is in network communication with the client computing device 102 (via network 104), and the client computing device 102 includes a processor 302 and memory 304. The memory 304 has a web browser 306 loaded therein. The web browser 306 has a generative model interface 308 incorporated therein, where the web browser 306 provides information to the content delivery module 110 and/or generative model 112 by way of the generative model interface 308. Similarly, the content delivery module 110 and/or generative model 112 provides information to the web browser 306 by way of the generative model interface 308. When content delivery module 110 causes content to be displayed at the client computing device 102, it may be displayed at the browser 306 and/or the generative model interface 308. In an example, the content may be presented within the generative model interface 308 in addition to the output of the generative model. Additionally, the content delivery module 110 may cause portions of the conversational data displayed at the generative model interface 308 with anchor text to be graphically emphasized (e.g., by highlighting, changing font size, changing font type, etc.). The content delivery module 110 may further cause content to be presented to the user at the browser 306.

In another example, the content delivery module 110 causes content to be displayed at the client computing device 102 as a graphical object overlay presented on top of the generative model interface 308. The anchor text within the conversational data is emphasized by the content delivery module 110 such that when a user interacts with the anchor text (e.g., via a cursor “hover”, click, etc.) the content provided by the content delivery module 110 is caused to be displayed as a graphical object overlay on top of the generative model interface.

Another aspect of system 100 as depicted in FIG. 3 is the content server 310. Upon generation of the content query, the content delivery module 110 obtains content responsive to the content query. In an example, the content delivery module 110 may receive content based upon the content query from the content server 310. The content server 310 may execute a content acquisition service 312 whereby different content providers can provide content responsive to the content query. In a further example, the content acquisition service 312 can solicit content in an auction format, whereby different content providers can provide bids for the opportunity to provide the content to the content delivery module 110. The content delivery module may provide the content providers (e.g., via the content server 310) certain information relating to the user of the client computing device (e.g., user profile information, demographic information, information relating to current or past conversational data, etc.). In another example, the content delivery module 110 may generate content based upon the content query. Content generated by the content delivery model 110 may comprise content stored in the asset data store 124. Additionally, content may be generated using content stored in the asset data store 124 (e.g., by way of the generative model 112 and/or a seq2seq model).

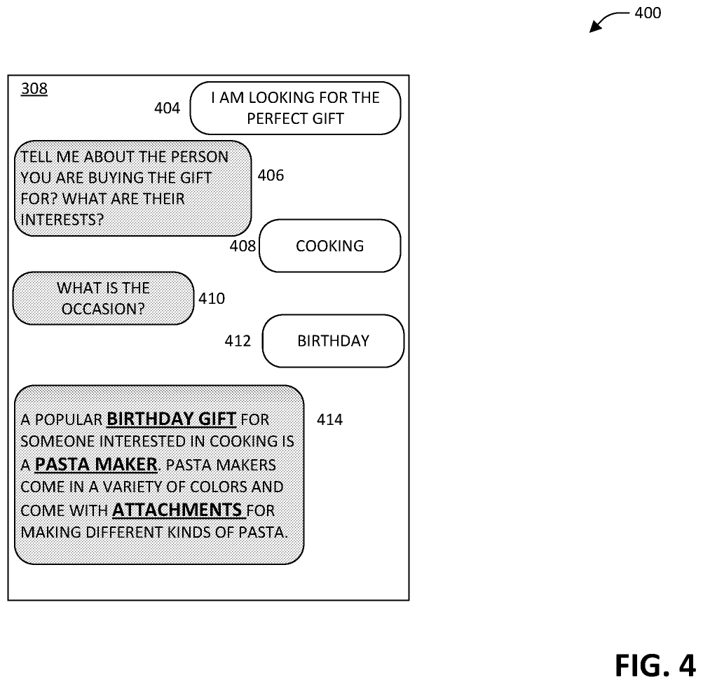

Further operation of the computing system 101 is described with reference to FIG. 4, which illustrates an exemplary GUI 400. The GUI 400 comprises generative model interface 308 executing at computing device 102. An input query set forth by a user is illustrated at 404. The query 404 is “I am looking for the perfect gift.” The query 404 is provided to the generative model 112 by way of the generative model interface 308. A responsive output 406 is generated by the generative model 112. The responsive output 406 is “Tell me about the person you are buying the gift for?What are their interests?” At this point, the query 404 and responsive output 406 may be provided to the content delivery module 110 as conversational data. In some embodiments, a predetermined number of query-response exchanges will trigger transmission of the conversational data to the content delivery module 110. In some embodiments, the conversational data is transmitted to the content delivery module 110 after each dialog turn, however, the content delivery module 110 may not initiate the content delivery process until certain parameters are satisfied (e.g., a certain number of dialog turns, a certain number of words, etc.).

Continuing with the above example, the responsive output 406 is replied to with the answer “cooking” at input 408. The generative model 112 produces further output in the form of a question 410 “What is the occasion?” The user sets forth a reply 412 “birthday.” At this point, the conversational data comprises user inputs 404-412 and generative model outputs 406 and 410. This conversational data is used by the content delivery module 110 to determine a user intent at the intent classification module 114. More specifically, the conversational data is provided as input into the intent classification module 114 where the intent classification module 114 produces an output indicative of an intent associated with the conversational data. As the conversational data in the above example relates to the identification of an item or product to purchase as a gift, the output of the intent classification module 114 would be a commercial intent. While the commercial intent is appropriate given the conversational data in the above example, it is appreciated that different intent outputs may be appropriate for different types of conversational data.

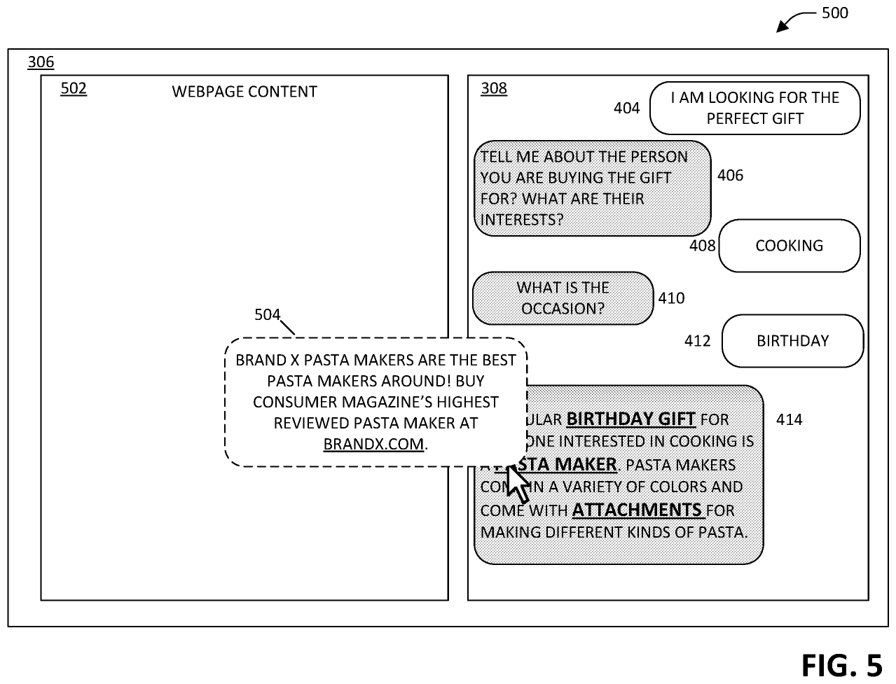

Continuing with the above example, upon an output of the intent classification module 114 indicative of a “commercial” intent, the conversational data and the output of the intent classification module 114 are provided to the anchor generation module 116. The anchor generation module 116 generates anchor text indicative of portions of the conversational data correlated with the user intent as indicated by the intent classification module 114. The content delivery module 110 then generates a content query based upon the anchor text and obtains content responsive to the query. Meanwhile, the generative model 112 generates a responsive output 414 which details a particular gift that is responsive to the queries set forth by the user. Specifically, output 414 states “A popular birthday gift for someone interested in cooking is a pasta maker. Pasta makers come in a variety of colors and come with attachments for making different kinds of pasta.” in this example, anchor text “birthday gift”, “pasta maker”, and “attachments” are shown graphically emphasized (underlined, bolded, increased font size, etc.) within the output 414. In this example, the content provided by the content delivery module 110 is hidden until the anchor text is interacted with by the user. It is appreciated that the anchor text may be associated with one or more items of content as provided by content delivery module 110. Hiding the content until user interaction is received results in a streamlined interface where the additional content provided by the content delivery module 110 is not distracting or obtrusive within the generative model interface 308. An example interaction of this hidden content is depicted in FIG. 5.

FIG. 5 is an illustration of exemplary GUI 500. The GUI 500 comprises a browser 306 and a generative model interface 308 executing within. In addition to generative model interface 308, the browser 306 is also displaying webpage content 502. The generative model interface 308 shows the same conversational data interaction as with FIG. 4. Additionally, the user has set forth an interaction with the anchor text within output 414 which triggers display of content 504. In this example, interaction with the anchor text “pasta maker” triggers display of content 504 which states “Brand X pasta makers are the best pasta makers around!Buy consumer magazine's highest reviewed pasta maker at brandx.com.” In this example, the content 504 is a text-based advertisement for Brand X pasta makers with a hyperlink to the brandx.com website (as indicated by underline). More specifically, the content 504 is a graphical element that is configured to overlay on top of the content displayed by browser 306 (e.g., the webpage content 502 and the generative model interface 308). It is appreciated that content 504 is content associated with specific anchor text, and that interaction with the other anchor text within output 414 would trigger display of alternative content. However, in certain cases, interaction with any anchor text may cause the same content to be displayed.

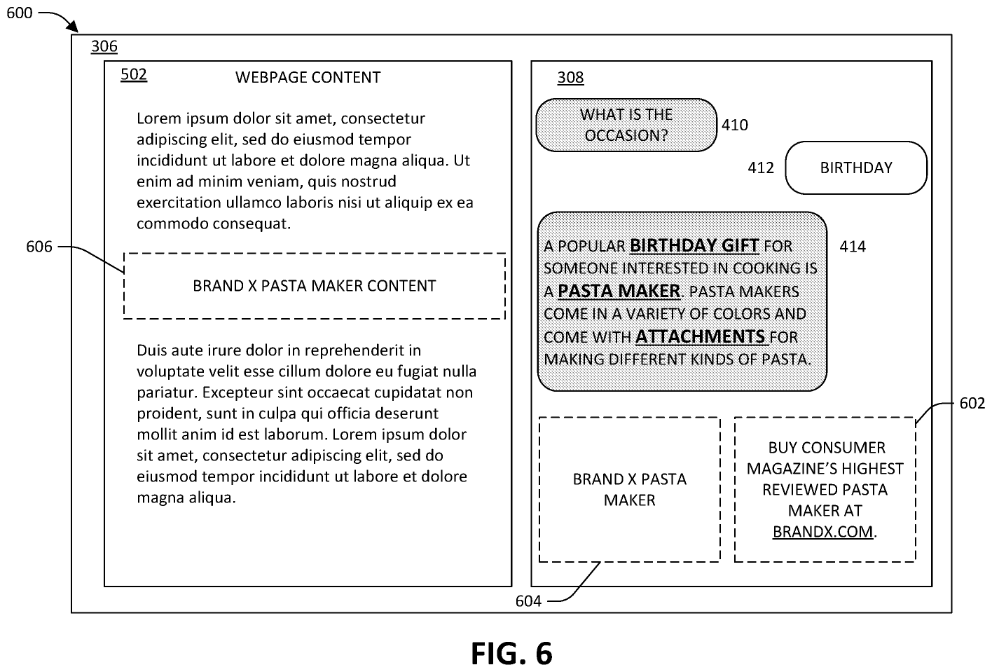

FIG. 6 is an illustration of exemplary GUI 600. The GUI 600 comprises a browser 306 and a generative model interface 308 executing within. In addition to generative model interface 308, the browser 306 is also displaying webpage content 502. The generative model interface 308 shows the same conversational data interaction as with FIGS. 4-5. However, in the example illustrated by GUI 600, content delivery module 110 has caused content to be displayed within the webpage content 502 and the generative model interface 308. Content 606 is content that is dispersed within the webpage content 502. As with other content as described herein, it is appreciated that when interacted with by the user of the browser 306, the content 606 may cause the browser to navigate to a webpage associated with content 606. Additionally, content 602 and content 604 are caused to appear within the generative model interface 308. Content 604 may be an image of a Brand X pasta maker, while content 602 is textual content with a hyperlink to the brandx.com website (as indicated by underline).

While FIG. 5-6 illustrate different types of content as displayed at a browser 306, it is appreciated that both types of content may be delivered by content delivery module 110.

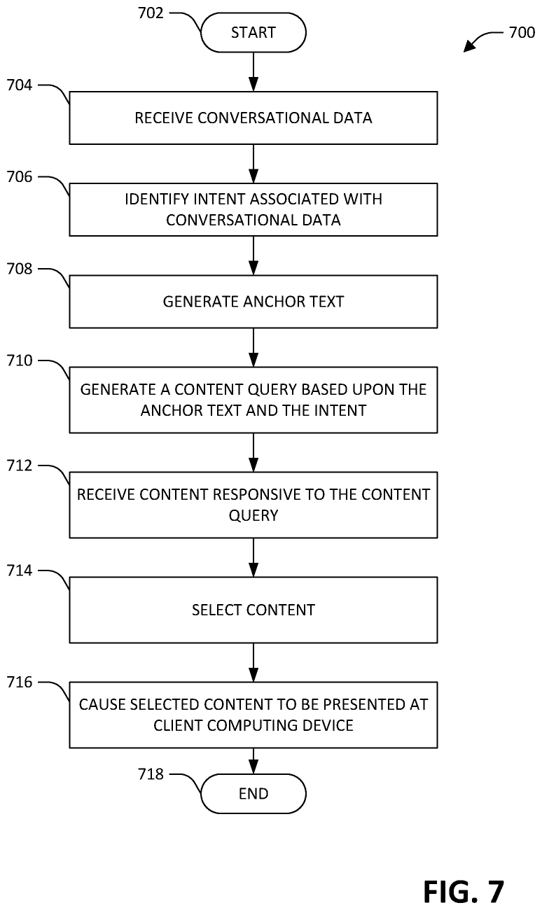

FIG. 7 illustrates an exemplary methodology relating to providing content to a client computing device based upon conversational data resulting from the interaction between the client computing device (e.g., client computing device 102) and a generative model (e.g., generative model 112). While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 7, a methodology 700 for providing content to a client computing device based upon conversational data is illustrated. The methodology 700 starts at 702, and comprises, receiving conversational data at 704. As described herein, conversational data is the result of an interaction between a client computing device (e.g., client computing device 102) and a generative model (e.g., generative model 112). More specifically, a user operating the client computing device sets forth an input which is provided to the generative model. Upon receiving the input, the generative model produces a responsive output. The information exchanged between the client computing device and the generative model make up the conversational data. Conversational data may further include historical conversational data generation through prior interaction between the client computing device and the generative model. At 706, an intent associated with the conversational data is identified. As an example, the conversational data is provided as input into an intent classification module (e.g., intent classification module 114) which produces an output indicative of an intent associated with the conversational data. At 708, anchor text is generated (e.g., via anchor generation module 116). The anchor text is generated based upon the conversational data and the user intent as indicated by the intent classification module. The anchor text is indicative of one or more portions of the conversational data that are correlated with the user intent.

At 710, a content query is generated (e.g., via content query generation module 118) based upon the anchor text and the user intent. Execution of the content query identifies content responsive to the query. As the content query may return multiple items of content, the content that is to be displayed at the user computing device is selected at 714 (e.g., via content selection module 120). At 716, the selected content is caused to be presented at the client computing device. The methodology terminates at 718.

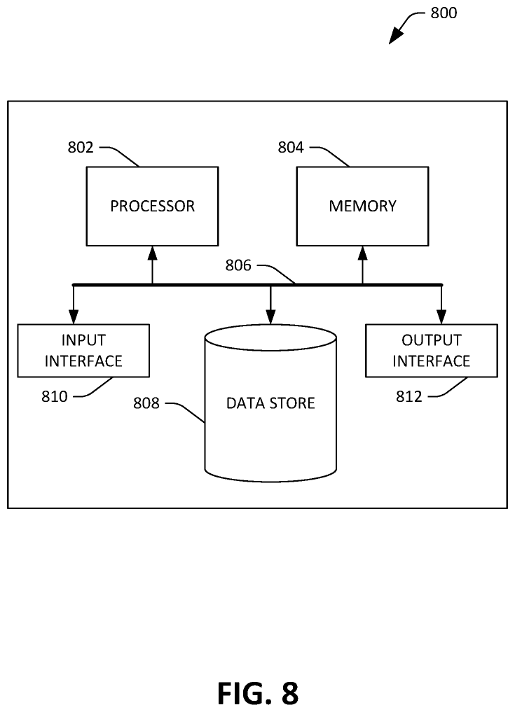

Referring now to FIG. 8, a high-level illustration of an exemplary computing device 800 that can be used in accordance with the systems and methodologies disclosed herein is illustrated. For instance, the computing device 800 may be used in a system that is configured provided content to a client computing device based upon conversational data resulting from the interaction between the client computing device and a generative model. The computing device 800 includes at least one processor 802 that executes instructions that are stored in a memory 804. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store prompts, historical data, content, etc.

The computing device 800 additionally includes a data store 808 that is accessible by the processor 802 by way of the system bus 806. The data store 808 may include executable instructions, instant answers, a web index, etc. The computing device 800 also includes an input interface 810 that allows external devices to communicate with the computing device 800. For instance, the input interface 810 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

It is contemplated that the external devices that communicate with the computing device 800 via the input interface 810 and the output interface 812 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 800 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 800 may be a distributed system. Thus, for instance, several devices may be in communication by way of a network connection and may collectively perform tasks described as being performed by the computing device 800.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium.

Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Described herein are various features pertaining to providing content to a client computing device based upon conversational data resulting from the interaction between the client computing device and a generative model. The various features are understood with at least the following examples.

(A1) In an aspect, a method (e.g., performed by a processor a computing system) described herein comprises receiving conversational data comprising an input set forth by a user of a client computing device and output generated by a generative model responsive to receiving the input. The method additionally comprises providing the conversational data to an intent classification module, wherein the intent classification module produces an output indicative of a user intent based upon the conversational data. The method further comprises providing the conversational data and the output indicative of a user intent as input into an anchor generation module. The anchor generation module generates anchor text based upon the conversational data and the output, wherein the anchor text is indicative of portions of the conversational data correlated with the user intent. The method additionally comprises generating a content query based upon the anchor text and obtaining content responsive to the content query. The method additionally comprises transmitting the content to the client computing device for presentation to the user.

(A2) In some embodiments of the exemplary method of (A1), generating the content query based upon the anchor text comprises generating a content query generation prompt, wherein the content query generation prompt comprises the anchor text and user profile information associated with the user. Generating the content query further comprises providing the content query generation prompt as input into an instance of the generative model and receiving, from the instance of the generative model, an output comprising the content query.

(A3) In some embodiments of the method of at least one of (A1)-(A2), the method further comprises at the intent classification module, generating an intent classification prompt, wherein the intent classification prompt comprises the conversational data and user profile information associated with the user. The method further comprises providing the intent classification prompt as input into an instance of the generative model associated with the intent classification module and receiving, from the instance of the generative model, an output indicative of a user intent, wherein the output is based upon the conversational data and the user profile information.

(A4) In some embodiments of the method of at least one of (A1)-(A3), the intent classification module comprises a sequence-to-sequence model configured to produce the output indicative of a user intent based upon the conversational data.

(A5) In some embodiments of the method of at least one of (A1)-(A4), obtaining content responsive to the content query comprises receiving content provided from a content server, wherein the content provided from the content server is obtained based upon a content auction at the content server.

(A6) In some embodiments of the method of at least one of (A1)-(A5), obtaining the content responsive to the content query additionally and/or alternatively comprises generating a content generation prompt based upon the content query and a content asset obtained from a content asset data store, providing the content generation prompt as input into an instance of the generative model, and receiving, from the instance of the generative model, an output comprising content responsive to the content query.

(A7) In some embodiments of the method of at least one of (A1)-(A6), the method additionally comprises determining a score representative of a likelihood that a content will be interacted with at the client computing device, selecting the content with the highest score, and transmitting the content with the highest score to the client computing device.

(A8) In some embodiments of the method of at least one of (A1)-(A7), the method further comprises causing anchor text within the conversational data to be graphically emphasized when presented at the client computing device.

(A9) In some embodiments of the method of at least one of (A1)-(A8), the method further comprises causing the content to be presented to the user at the client computing device upon a user interaction with the anchor text, wherein the content is presented as a graphical overlay at the client computing device.

(A10) In some embodiments of the method of at least one of (A1)-(A9), the conversational data is received from the generative model.

(A1 l) In some of the embodiments of the method of at least one of (A1)-(A10), the conversational data, additionally and/or alternatively, comprises data from a first interaction between the client computing device and the generative model and a second interaction between the client computing device and the generative model, wherein the first interaction preceded the second interaction.

(A12) In some of the embodiments of the method of at least one of (A1)-(A11), the content is presented within a generative model interface.

(A13) In some of the embodiments of the method of at least one of (A1)-(A12), the content is supplemental to webpage content concurrently displayed at the client computing device.

(B1) In another aspect, a method (e.g., performed by a processor a computing system) described herein comprises receiving conversational data from a conversational model. The conversational data comprises output generated by the conversational model responsive to receiving an input set forth by a user of a client computing device. The method additionally comprises providing the conversational data to an intent classification module, wherein the intent classification module produces an output indicative of a user intent based upon the conversational data. The method further comprises providing the conversational data and the output indicative of a user intent as input into an anchor generation module, wherein the anchor generation module generates anchor text. The anchor text is indicative of one or more portions of the conversational data correlated with the user intent. The method further comprises generating a content query based upon the anchor text, obtaining content responsive to the content query, and transmitting the content to the client computing device for presentation to the user.

(B2) In some embodiments of the method of (B1), the generating of the content query further comprises generating a content query generation prompt, wherein the content query generation prompt comprises the anchor text and user profile information associated with the user. Generating the content query further comprises providing the content query generation prompt as input into a model and receiving, from the model, an output comprising the content query.

(B3) In some embodiments of the method of at least one of (B1)-(B2), the method further comprises at the intent classification module, generating an intent classification prompt, wherein the intent classification prompt comprises the conversational data and user profile information associated with the user. The method additionally comprises providing the intent classification prompt as input into an instance of a model associated with the intent classification module and receiving, from the instance of the model, an output indicative of a user intent based upon the conversational data and the user profile information.

(B4) In some embodiments of the method of at least one of (B1)-(B3), the intent classification module comprises a sequence-to-sequence model configured to produce the output indicative of a user intent based upon the conversational data.

(C1) In yet another aspect, a computing system comprises a processor and memory, where the memory stores instructions that, when executed by the processor, cause the processor to perform at least one of the methods disclosed herein (e.g., any of the methods of (A1)-(A13) or (B1)-(B4)).

(D1) In yet another aspect, a computer-readable storage medium includes instructions that, when executed by a processor, cause the processor to perform at least one of the methods disclosed herein (e.g., any of the methods of (A1)-(A13) or (B1)-(B4)).

(D2) In some embodiments of the computer-readable storage medium of (D1), the acts performed by the processor further comprise generating a content query generation prompt, wherein the content query generation prompt comprises the anchor text and user profile information associated with the user. The acts additionally comprise providing the content query generation prompt as input into a model and receiving, from the model, an output comprising the content query.

(D3) In some embodiments of the computer-readable storage medium of at least one of (D1)-(D2), obtaining the content responsive to the content query comprises generating a content generation prompt based upon the content query and a content asset obtained from a content asset data store, providing the content generation prompt as input into a model, receiving, from the model, an output comprising content responsive to the content query.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
receiving conversational data comprising an input set forth by a user of a client computing device and output generated by a generative model responsive to receiving the input;
providing the conversational data to an intent classification module, wherein the intent classification module produces an output indicative of a user intent based upon the conversational data;
providing the conversational data and the output indicative of a user intent as input into an anchor generation module, wherein the anchor generation module generates anchor text based upon the conversational data and the output, wherein the anchor text is indicative of portions of the conversational data correlated with the user intent;
generating a content query based upon the anchor text;
obtaining content responsive to the content query; and
transmitting the content to the client computing device for presentation to the user.

2. The computing system of claim 1, wherein generating the content query based upon the anchor text comprises:
generating a content query generation prompt, wherein the content query generation prompt comprises the anchor text and user profile information associated with the user; and
providing the content query generation prompt as input into an instance of the generative model; and
receiving, from the instance of the generative model, an output comprising the content query.

3. The computing system of claim 1, the acts further comprising:
at the intent classification module, generating an intent classification prompt, wherein the intent classification prompt comprises the conversational data and user profile information associated with the user;
providing the intent classification prompt as input into an instance of the generative model associated with the intent classification module; and
receiving, from the instance of the generative model, an output indicative of a user intent, wherein the output is based upon the conversational data and the user profile information.

4. The computing system of claim 1, wherein the intent classification module comprises a sequence-to-sequence model configured to produce the output indicative of a user intent based upon the conversational data.

5. The computing system of claim 1, wherein obtaining content responsive to the content query comprises:
receiving content provided from a content server, wherein the content provided from the content server is obtained based upon a content auction at the content server.

6. The computing system of claim 1, wherein obtaining the content responsive to the content query comprises:
generating a content generation prompt based upon the content query and a content asset obtained from a content asset data store; and
providing the content generation prompt as input into an instance of the generative model; and
receiving, from the instance of the generative model, an output comprising content responsive to the content query.

7. The computing system of claim 1, the acts further comprising:
wherein when the content obtained responsive to the content query comprises a plurality of content, determining a score representative of a likelihood that a content will be interacted with at the client computing device;
selecting the content with the highest score; and
transmitting the content with the highest score to the client computing device.

8. The computing system of claim 1, the acts further comprising:
causing anchor text within the conversational data to be graphically emphasized when presented at the client computing device.

9. The computing system of claim 8, the acts further comprising:
causing the content to be presented to the user at the client computing device upon a user interaction with the anchor text, wherein the content is presented as a graphical overlay at the client computing device.

10. The computing system of claim 1, wherein the conversational data is received from the generative model.

11. The computing system of claim 10, wherein the conversational data comprises data from a first interaction between the client computing device and the generative model and a second interaction between the client computing device and the generative model, wherein the first interaction preceded the second interaction.

12. The computing system of claim 10, wherein the content is presented within a generative model interface.

13. The computing system of claim 10, wherein the content is supplemental to webpage content concurrently displayed at the client computing device.

14. A method comprising:
receiving conversational data from a conversational model, wherein the conversational data comprises output generated by the conversational model responsive to receiving an input set forth by a user of a client computing device;
providing the conversational data to an intent classification module, wherein the intent classification module produces an output indicative of a user intent based upon the conversational data;
providing the conversational data and the output indicative of a user intent as input into an anchor generation module, wherein the anchor generation module generates anchor text, wherein the anchor text is indicative of one or more portions of the conversational data correlated with the user intent;
generating a content query based upon the anchor text;
obtaining content responsive to the content query; and
transmitting the content to the client computing device for presentation to the user.

15. The method of claim 14, wherein generating the content query based upon the anchor text comprises:
generating a content query generation prompt, wherein the content query generation prompt comprises the anchor text and user profile information associated with the user;
providing the content query generation prompt as input into a model; and
receiving, from the model, an output comprising the content query.

16. The method of claim 14, further comprising:
at the intent classification module, generating an intent classification prompt, wherein the intent classification prompt comprises the conversational data and user profile information associated with the user; and
providing the intent classification prompt as input into an instance of a model associated with the intent classification module; and
receiving, from the instance of the model, an output indicative of a user intent based upon the conversational data and the user profile information.

17. The method of claim 16, wherein the intent classification module comprises a sequence-to-sequence model configured to produce the output indicative of a user intent based upon the conversational data.

18. A computer-readable storage medium comprising instructions that, when executed by a processor, cause the processor to perform acts comprising:
receiving conversational data, wherein the conversational data comprises output generated by the generative model responsive to receiving an input set forth by a user of a client computing device;
providing the conversational data to an intent classification module, wherein the intent classification module produces an output indicative of a user intent based upon the conversational data;
providing the conversational data and the output indicative of a user intent as input into an anchor generation module, wherein the anchor generation module generates anchor text, wherein the anchor text is indicative of portions of the conversational data correlated with the user intent;
generating a content query based upon the anchor text;
obtaining content responsive to the content query; and
causing the content to be presented at the client computing device.

19. The computer-readable storage medium of claim 18, further comprising:
generating a content query generation prompt, wherein the content query generation prompt comprises the anchor text and user profile information associated with the user; and
providing the content query generation prompt as input into a model; and
receiving, from the model, an output comprising the content query.

20. The computer-readable storage medium of claim 18, wherein obtaining the content responsive to the content query comprises:
generating a content generation prompt based upon the content query and a content asset obtained from a content asset data store;
providing the content generation prompt as input into a model; and
receiving, from the model, an output comprising content responsive to the content query.
